(19) United States
(12) Patent Application Publication
(10) Pub. No.: US 2010/0043720 A1
(43) Pub. Date: Feb. 25, 2010

(54) Animal Crate Apparatus

(76) Inventor: Peter F. Yelverton, Celebration, FL (US)

Correspondence Address: LARRY D. JOHNSON, P.O. BOX 470277, CELEBRATION, FL, 34747, US

(21) Appl. No.: 12/536,207

(22) Filed: Aug. 5, 2009

Related U.S. Application Data
(60) Provisional application No. 61/188,121, filed on Aug. 6, 2008.

(51) Int. Cl. A01K 1/03

(52) U.S. Cl. 119/496; 119/501

(57) ABSTRACT

A crate apparatus suitable for housing and transporting dogs and other animals includes a crate body having a front wall, back wall, two side walls, a top, and a bottom. The front and back walls each preferably have a hinged door with pinch-type fasteners, enabling access from either end of the crate. The interior of the crate may be partitioned by selectively installing one or more dividers substantially spanning the side walls, top, and bottom, with each resulting section of the divided crate being accessible by its own door. At least one side wall preferably includes an integral slot, seat belt pass-through, or other means for attachment of the crate to a vehicle seat belt for secure transport.

### CROSS REFERENCE TO RELATED APPLICATIONS

The present application claims the benefit of the filing date of U.S. Provisional Patent Application Ser. No. 61/188,121, filed Aug. 6, 2008, and hereby incorporated in its entirety herein by reference.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to animal and pet supplies, and more particularly to an improved crate apparatus for housing and transporting dogs, cats, and other animals.

### BACKGROUND INFORMATION AND DISCUSSION OF RELATED ART

There are numerous problems with existing animal crates. For example, people acquiring a puppy and desiring to use an animal crate will likely have to purchase multiple crates over the pet's lifetime as the dog increases in size. Also, pet owners with more than one dog may have to purchase a separate crate for each dog. In addition, many animal crates are difficult to secure in a vehicle and are therefore unsafe for travel.

U.S. Pat. No. 7,228,820 to Kellogg, et al. discloses an adjustable kennel which provides an enclosure for an animal that is lightweight, expandable and collapsible for storage and travel. The kennel has a semi-rigid frame that can be adjusted for size and an expandable, pliable cover allowing the kennel to be adjusted appropriately for the size of the animal occupying it. When in use, the frame includes slidably expandable support members such that the kennel can accommodate different sized animals or can be adjusted to be used over a long period of time as an animal grows.

U.S. Pat. Des. 374,510 to Barreto, III et al. discloses a more or less standard pet carrier.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### SUMMARY OF THE INVENTION

The present invention provides a crate apparatus suitable for housing and transporting dogs and other animals. The inventive apparatus includes a crate body having a front wall, back wall, two side walls, a top, and a bottom. The front and back walls each preferably have a hinged door with pinch-type fasteners, enabling access from either end of the crate. The interior of the crate may be partitioned by selectively installing one or more dividers substantially spanning the side walls, top, and bottom, with each resulting section of the divided crate being accessible by its own door. At least one side wall preferably includes an integral slot, seat belt pass-through, or other means for attachment of the crate to a vehicle seat belt for secure transport.

In a first preferred embodiment, one side wall of the crate includes a plurality of vertical, full-height slots enabling lateral insertion of one or more panels or dividers to partition the interior of the crate into the desired size sections. In a preferred arrangement, three slots are placed in the side wall at ¼, ½, and ¾ of the distance between the front and back walls, so that insertion of a divider into the first (or third) slot effectively partitions the crate into a smaller (¼) size section and a larger (¾) size section, or insertion of a divider into the second slot effectively partitions the crate into two equal half sections, with each section being accessible from a door at the respective ends. This enables the user to adjust the size of the crate to accommodate the growth of a dog or multiple dogs over time. The bottom of the crate may include a detachable, wheeled base portion which preferably includes a storage area for the divider(s) when they are not being used.

In a second embodiment, the top of the crate includes a plurality of lateral, full-width slots enabling vertical insertion of one or more dividers to partition the interior of the crate into the desired size sections. At least one of the side walls preferably includes a window and/or vents.

In a third embodiment, the front, back, and side walls of the crate are configured in a hinged or clamshell-type arrangement, with the inside surfaces of the side walls and/or top and bottom bearing slots for locating a divider to partition the crate into the desired size sections.

The inventive animal crate apparatus is thus designed to accommodate the growth of a dog during its life span from adolescence to adulthood. It may also accommodate multiple dog households in which one crate can serve two dogs (size depending), with each end of the divided crate accessible by its own door. The addition of the integral slot or seat belt pass-through safety attachment to the crate allows the crate to be seat-belted to standard vehicle seatbelts and increases the safety of traveling with a pet or pets.

Benefits of the inventive apparatus include, but are not limited to, the following:

Cost savings as the pet owner does not need to purchase multiple crates as the dog grows. The dog becomes accustomed to one crate and therefore is more relaxed and comfortable with familiar surroundings.

Cost savings for the pet owner as one crate could be used for two dogs and still provide needed personal space for each dog.

Increased safety for dog/dogs when traveling.

Superior construction provides long term use as well as adaptability if different breeds of dogs are acquired during an owner's lifetime.

It is therefore an object of the present invention to provide a new and improved animal crate that can grow with an animal's life cycle.

It is another object of the present invention to provide a new and improved animal crate that provides a comfortable space as well as an excellent source for crate training.

A further object or feature of the present invention is a new and improved animal crate that provides additional safety, especially for multiple dogs and large dogs, when traveling.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a first preferred embodiment of an animal crate apparatus of this invention, with a laterally inserted divider;

FIG. 2 is a cutaway top perspective view of the crate apparatus of FIG. 1 illustrating the partitioning of the interior of the crate by the divider;

FIG. 3 is a perspective view of a second embodiment of the crate apparatus of this invention, with a vertically inserted divider; and

FIG. 4 is a perspective view of a third embodiment of the crate apparatus of this invention, with internal slots for locating a divider in a clamshell-type crate body.

### DETAILED DESCRIPTION OF THE INVENTION

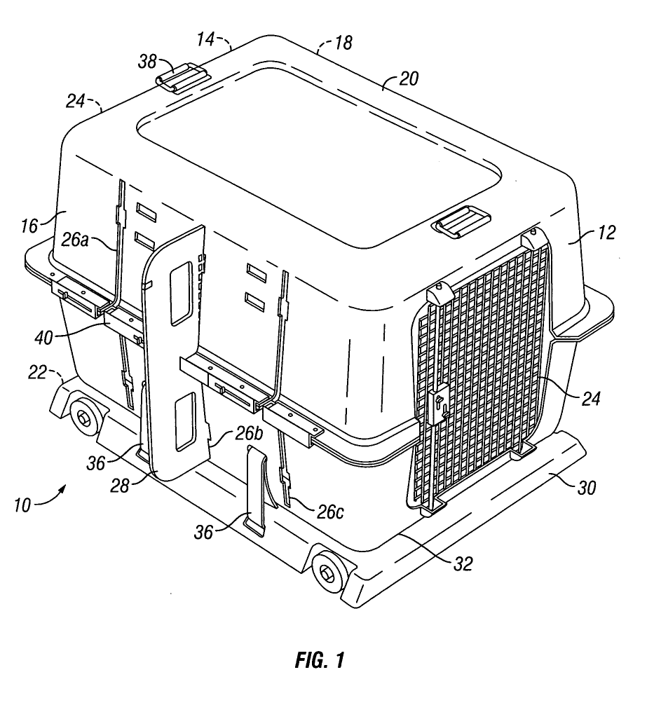

Referring to FIGS. 1 through 4, wherein like reference numerals refer to like components in the various views, there is illustrated therein a new and improved animal crate apparatus, generally denominated 10 herein.

FIG. 1 is a perspective view of a first preferred embodiment of an animal crate apparatus of this invention. Crate 10 includes front end or wall 12, back end or wall 14, two side walls 16, 18, a top 20, and a bottom 22. The front and back walls 12, 14 each preferably include a hinged door 24 with pinch fasteners, enabling access from either end of the crate. One side wall 16 of the crate includes a plurality of vertical, full-height slots 26a, 26b, 26c enabling lateral insertion of one or more panels or dividers 28 to partition the interior of the crate into the desired size sections. In a preferred arrangement, the three slots are placed in the side wall at ¼, ½, and ¾ of the distance between the front and back walls, respectively, so that insertion of a divider into the first slot 26a or third slot 26c effectively partitions the crate into a smaller (¼) size section and a larger (¾) size section, or insertion of a divider into the second slot 26b effectively partitions the crate into two equal half sections, with each section being accessible from a door 24 at the respective ends 12, 14. The bottom of the crate may include a detachable, wheeled base portion 30 which preferably includes a storage area 32 for the divider(s) when they are not being used. Side wall 16 preferably includes an integral slot 34 which may be used with a webbing tie down 36 to secure the crate to the base 30, or as a seat belt pass-through for attachment to a vehicle seat belt for secure transport. Spring loaded handles 38 may assist in moving the crate. Slide locks 40 may be used to secure a divider in position, and prevent inadvertent removal.

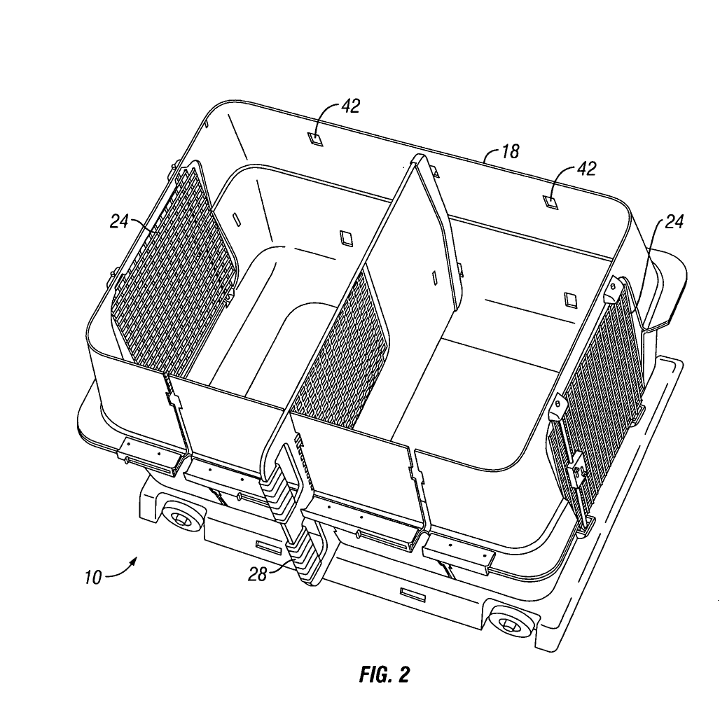

FIG. 2 is a cutaway top perspective view of the crate apparatus 10 of FIG. 1 illustrating the partitioning of the interior of the crate by the divider 28. Locating slots 42 may be used to engage corresponding tabs on the end of the divider to fix the divider in position on side wall 18.

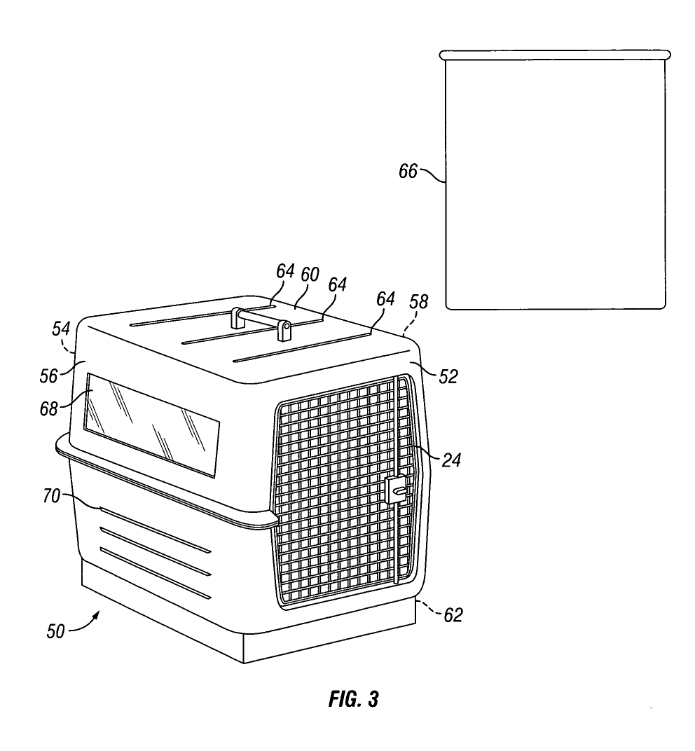

FIG. 3 is a perspective view of a second embodiment 50 of the crate apparatus of this invention. Crate 50 includes front wall 52, back wall 54, two side walls 56, 58, a top 60, and a bottom 62. The crate top 60 includes a plurality of lateral, full-width slots 64 enabling vertical insertion of one or more panels or dividers 66 to partition the interior of the crate into the desired size sections. One side wall 56 preferably includes a window 68 and/or air vents 70. As with the first embodiment, insertion of a divider 66 into a slot effectively partitions the crate into sections, each accessible from the doors 24 at the respective ends 52, 54.

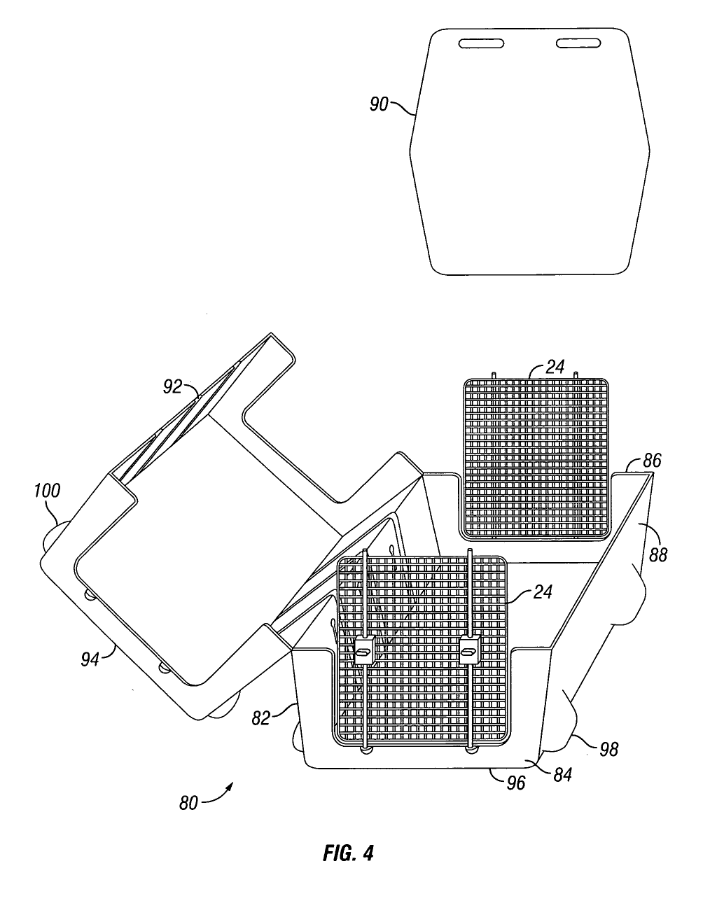

FIG. 4 is a perspective view of a third embodiment 80 of the crate apparatus of this invention. Here, side wall 82 is hinged, and front wall 84, back wall 86, and side wall 88 are split, creating a clamshell-type crate body. Divider 90 may be selectively placed in one of a plurality of sets of internal slots 92 in the side walls 82 and 88, and/or top 94 and bottom 96, and the clamshell closed and secured, to partition the crate into the desired size sections. As with the previous embodiments, insertion of a divider 90 into a slot effectively partitions the crate into sections, each accessible from the doors 24 at the respective ends 84, 86. Casters may be inserted into receivers 98 on the bottom 96 to facilitate moving of the crate, and removed and placed into complementary receivers 100 on the top for storage.

The crate is preferably constructed of durable ABS plastic or other suitable material. The crate can be manufactured in various sizes, for example, outside dimensions of 46.4 inches long, 34.4 inches wide, and 30.0 inches high. Assuming an inside length dimension of 40.4 inches, placement of a divider into one of the preferred ¼, ½, or ¾ positions results in a section length in one end of the crate of 10.5 inches, 20.9 inches, or 31.3 inches, respectively, or a full 40.4 inches with the divider removed.

Accordingly, the invention may be characterized as a crate apparatus for housing and transporting dogs and other animals, comprising a crate body having a front wall, back wall, first side wall, second side wall, a top, and a bottom; a door in the front and back walls; at least one divider substantially spanning the first and second side walls, top, and bottom, the divider dividing the interior of the crate body into two sections each accessible by a door. The first side wall of the crate body may include a plurality of vertical, full-height slots enabling lateral insertion of the at least one divider to partition the interior of the crate body into the desired size sections. Alternatively, the top may includes a plurality of lateral, full-width slots enabling vertical insertion of the at least one divider to partition the interior of the crate body into the desired size sections. Still further, the first side wall, second side wall, front, and back of the crate body may be configured in a clamshell arrangement, with the inside surfaces of at least some of the first side wall, second side wall, top, and bottom bearing slots for locating the divider to partition the crate body into the desired size sections.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A crate apparatus for housing and transporting dogs and other animals, said crate apparatus comprising:
a crate body having a front wall, back wall, first side wall, second side wall, a top, and a bottom;
a door in said front and back walls;
at least one divider substantially spanning said first and second side walls, top, and bottom, said divider dividing the interior of said crate body into two sections each accessible by a door.

2. The crate apparatus of claim 1 wherein said first side wall of said crate body includes a plurality of vertical, full-height slots enabling lateral insertion of said at least one divider to partition the interior of said crate body into the desired size sections.

3. The crate apparatus of claim 2 including three slots placed in said first side wall substantially at ¼, ½, and ¾ of the distance between said front and back walls.

4. The crate apparatus of claim 1 wherein said top includes a plurality of lateral, full-width slots enabling vertical insertion of said at least one divider to partition the interior of said crate body into the desired size sections.

5. The crate apparatus of claim 4 including three slots placed in said top substantially at ¼, ½, and ¾ of the distance between said front and back walls.

6. The crate apparatus of claim 1 wherein said first side wall, second side wall, front, and back of said crate body are configured in a clamshell arrangement, with the inside surfaces of at least some of said first side wall, second side wall, top, and bottom bearing slots for locating said divider to partition said crate body into the desired size sections.

7. The crate apparatus of claim 6 including three slots placed in said inside surfaces of at least some of said first side wall, second side wall, top, and bottom substantially at ¼, ½, and ¾ of the distance between said front and back walls.

8. The crate apparatus of claim 1 wherein said bottom includes a storage area for said at least one divider.

9. The crate apparatus of claim 1 wherein said bottom is detachable from said crate body.

10. The crate apparatus of claim 1 wherein at least one of said first wall and second wall includes means for attachment to a vehicle seat belt for secure transport.
